(19) United States
(12) Patent Application Publication
(10) Pub. No.: US 2024/0020610 A1
(43) Pub. Date: Jan. 18, 2024

(54) SUPPLY CHAIN ASSESSMENT TOOLS

(71) Applicant: Thurman Co., LLC, Houston, TX (US)

(72) Inventor: Angela Thurman, Houston, TX (US)

(73) Assignee: Thurman Co., LLC, Houston, TX (US)

(21) Appl. No.: 18/318,667

(22) Filed: May 16, 2023

Related U.S. Application Data
(60) Provisional application No. 63/342,225, filed on May 16, 2022.

(51) Int. Cl. G06Q 10/0635; G06Q 30/0203; G06Q 10/0639; G06Q 10/0631; G06N 5/022

(52) U.S. Cl. CPC G06Q 10/0635; G06Q 30/0203; G06Q 10/06393; G06Q 10/06315; G06N 5/022; G06Q 10/103

(57) ABSTRACT

Described herein are examples of a system that includes a client device and a server device with a supply chain assessment tool model. The server device may process, using natural language processing, responses to an electronic survey associated with assessing a supply chain. The server device may determine, based on processing the responses, supply chain information associated with the supply chain. The server may process, using a supply chain assessment tool model, the supply chain information to determine a level of risk associated with the supply chain. The server may determine, using the supply chain assessment tool model and based on the level of risk, an action item for the supply chain to reduce the level of risk. The server may cause, based on the action item, the client device or a supply chain management device associated with the supply chain to perform an action associated with the action item.

### CROSS-REFERENCE TO RELATED APPLICATIONS

The present application claims the benefit of U.S. Provisional Patent Application No. 63/342,225 entitled “SUPPLY CHAIN ASSESSMENT TOOLS”, filed on May 16, 2022. The entire contents of the above-listed application are hereby incorporated by reference for all purposes.

### BACKGROUND

Supply chains connect organizations, people, activities, information, and resources that are involved in supplying a product (e.g., a product for consumer use, a product utilized in a service, a product utilized by another entity in the supply chain, a product utilized in connection with another supply chain, or the like) to a receiving entity (e.g., an end consumer, business, or other type of entity that may utilize the product). Supply chain activities may involve operations associated with one or more of 1) supplying natural resources, raw materials, and components to sections of a supply chain 2) transforming, through the supply chain, the natural resources, the raw materials, and/or the components into one or more products, and/or 3) delivering the product to the receiving entity, amongst other examples. A disruption (e.g., a shutdown, a delay, a failure, or the like) in a supply chain (or to one of the supply chain activities) typically poses a variety of risks and can be costly to an owner or operator of the supply chain or downstream entities that rely on the products or operations of the supply chain.

### BRIEF DESCRIPTION OF THE DRAWINGS

The present description will be understood more fully when viewed in conjunction with the accompanying drawings of various examples of supply chain assessment tools. The description is not meant to limit one or more of the supply chain assessment tools to a specific example. Rather, the specific examples depicted and described are provided for explanation and understanding of supply chain assessment tools. Throughout the description the drawings may be referred to as drawings, figures, and/or FIGs.

FIG. 1 illustrates a supply chain assessment system, according to an embodiment.

FIG. 2 illustrates a device schematic for various devices used in the supply chain assessment system, according to an embodiment.

FIG. 3 illustrates an example associated with a supply chain assessment tool according to an embodiment.

FIG. 4 illustrates a first graphical user interface for accessing supply chain assessment data, according to an embodiment.

FIG. 5 illustrates a second graphical user interface for accessing supply chain assessment data, according to an embodiment.

FIG. 6 illustrates a third graphical user interface for accessing supply chain assessment data, according to an embodiment.

FIG. 7 illustrates a fourth graphical user interface for accessing supply chain assessment data, according to an embodiment.

FIG. 8 illustrates a fifth graphical user interface for accessing supply chain assessment data, according to an embodiment.

FIG. 9 illustrates a sixth graphical user interface for accessing supply chain assessment data, according to an embodiment.

FIG. 10 illustrates a seventh graphical user interface for accessing supply chain assessment data, according to an embodiment.

FIG. 11 illustrates a flow chart depicting a first supply chain assessment method, according to an embodiment.

FIG. 12 illustrates a flow chart for a supply chain assessment system, according to an embodiment.

### DETAILED DESCRIPTION

Supply chain assessment tools as disclosed herein will become better understood through a review of the following detailed description in conjunction with the figures. The detailed description and figures merely provide examples of various embodiments of supply chain assessment tools. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

Traditionally, assessing risk within a supply chain is performed by individuals collecting information from various sources and having the individuals manually enter the information into spreadsheets (or other similarly configured tables). The spreadsheets are typically equipped with hard-coded (or fixed) macros that determine results based on the information being manually entered into individual cells of the spreadsheets.

This manual process is time-consuming and tedious. Furthermore, this manual process is typically not comprehensive because the spreadsheets are dedicated to being utilized to assess specific topics (e.g., types of risks, compliance requirements, or the like) or portions of a supply chain. This process is also prone to various errors caused by, for example, one or more of the individuals mistyping the manually entered information into a particular cell and/or one or more of the individuals entering certain information into a cell that is designated to receive a different type of information. Further, obtaining useful results using the hard-coded macros requires that one or more individuals to have specialized knowledge of the spreadsheets and/or associated macros (e.g., the hard-coded macros) within the spreadsheets.

Implementations of the present disclosure may address some or all of the problems described above. As described herein, one or more supply chain assessment tools may assess levels of risk associated with one or more supply chains. For example, a supply chain assessment tool may provide an electronic survey (e.g., a web-based electronic survey or any similar set of inquiries) for analyzing a supply chain to a client. The supply chain assessment tool may receive data (e.g., responses to inquiries, questions, or prompts within the electronic survey) associated with the electronic survey from the client (e.g., at a server that hosts the supply chain assessment tool). The supply chain assessment tool may process, using one or more artificial intelligence techniques described herein, the data to determine and/or provide results of an analysis of risk to various aspects of the supply chain. As described herein, the supply chain assessment tool may provide the results, such as information identifying levels of risk to the supply chain, to the client. In some implementations, the results may include a list of action items to help identify, reduce, or manage risk. Furthermore, the results may trigger the client or other devices associated with the client to trigger actions (e.g., actions identified in the list of action items) to be performed.

As described herein, the supply chain assessment tool may be universally configured to be utilized to work with various topics and/or portions of a supply chain. For example, the electronic survey may include a series of inquiries or prompts that can cause an individual or device (e.g., a client device, sensor, or other type of device associated with a supply chain) to provide responses, data, or information that enables the supply chain assessment tool to analyze a variety of risks associated with a variety of different types of supply chains and/or a variety of different portions of the supply chains. Accordingly, a supply chain assessment tool, as described herein, may be scalable across multiple industries, usable by individuals with various levels of skill or expertise relative to a particular supply chain, and/or available for use in connection with assessing risk in various portions of supply chains to identify certain levels of risk involved in enabling an entity (e.g., an owner or operator of the supply chain) to provide a particular product or level of service.

Thus, the present disclosure provides a supply chain assessment tool that involves a technical solution that enables timely identification of levels of risk associated with a supply chain and avoids errors related to individuals manually entering information into spreadsheets, while enabling universal use with various supply chains (or types of supply chains) across various industries, thereby reducing a quantity of resources (e.g., computing resources, network resources, human resources, or the like), that would typically be required to assess levels of risk across the various supply chains across those various industries.

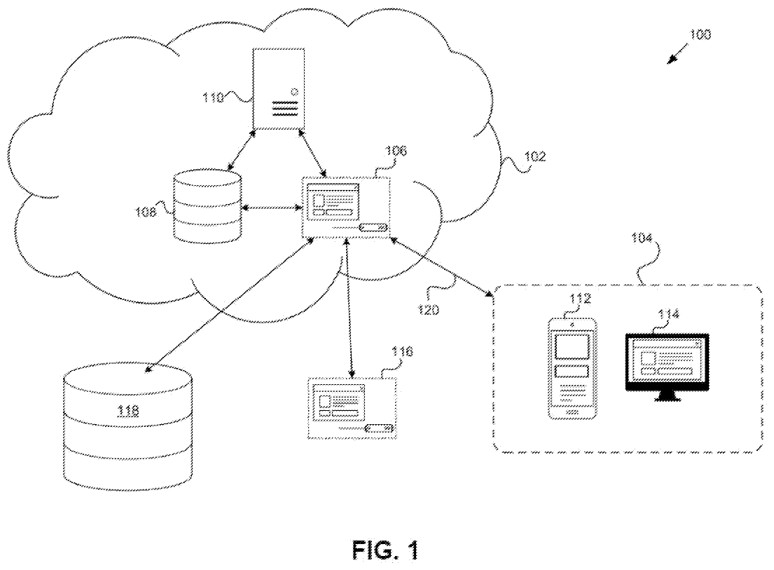

FIG. 1 illustrates a project management system 100, according to an embodiment. The project management system 100 includes internal and external data resources for managing a project. The project management system 100 may result in reduced memory allocation at client devices and may conserve memory resources for application servers.

The project management system 100 may include a cloud-based data management system 102 and a user device 104. The cloud-based data management system 102 may include an application server 106, a database 108, and a data server 110. The user device 104 may include one or more devices associated with user profiles of the project management system 100, such as a smartphone 112 and/or a personal computer 114. The project management system 100 may include external resources such as an external application server 116 and/or an external database 118. The various elements of the project management system 100 may communicate via various communication links 120. An external resource may generally be considered a data resource owned and/or operated by an entity other than an entity that utilizes the cloud-based data management system 102 and/or the user device 104.

The project management system 100 may be web-based. The user device 104 may access the cloud-based data management system 102 via an online portal set up and/or managed by the application server 106. The project management system 100 may be implemented using a public internet. The project management system 100 may be implemented using a private intranet. Elements of the project management system 100, such as the database 108 and/or the data server 110, may be physically housed at a location remote from an entity that owns and/or operates the project management system 100. For example, various elements of the project management system 100 may be physically housed at a public service provider such as a web services provider. Elements of the project management system 100 may be physically housed at a private location, such as at a location occupied by the entity that owns and/or operates the project management system 100.

The communication links 120 may be direct or indirect. A direct link may include a link between two devices where information is communicated from one device to the other without passing through an intermediary. For example, the direct link may include a Bluetooth™ connection, a Zigbee® connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links 120, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long term evolution (LTE) standard, and so forth. “Indirect,” when used regarding the communication links 120, may refer to any of the aforementioned indirect communication links.

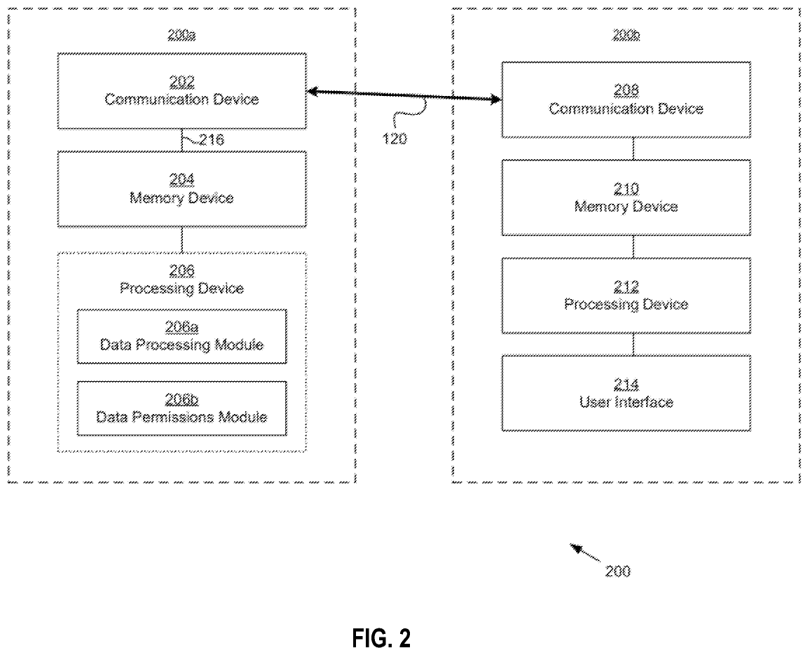

FIG. 2 illustrates a device schematic 200 for various devices used in the project management system 100, according to an embodiment. A server device 200a may moderate data communicated to a client device 200b based on data permissions to minimize memory resource allocation at the client device 200b.

The server device 200a may include a communication device 202, a memory device 204, and a processing device 206. The processing device 206 may include a data processing module 206a and a data permissions module 206b, where module refers to specific programming that governs how data is handled by the processing device 206. The client device 200b may include a communication device 208, a memory device 210, a processing device 212, and a user interface 214. Various hardware elements within the server device 200a and/or the client device 200b may be interconnected via a system bus 216. The system bus 216 may be and/or include a control bus, a data bus, and address bus, and so forth. The communication device 202 of the server device 200a may communicate with the communication device 208 of the client device 200b.

The data processing module 206a may handle inputs from the client device 200a. The data processing module 206a may cause data to be written and stored in the memory device 204 based on the inputs from the client device 200b. The data processing module 206a may retrieve data stored in the memory device 204 and output the data to the client device 200a via the communication device 202. The data permissions module 206b may determine, based on permissions data stored in the memory device, what data to output to the client device 200b and what format to output the data in (e.g. as a static variable, as a dynamic variable, and so forth). For example, a variable that is disabled for a particular user profile may be output as static. When the variable is enabled for the particular user profile, the variable may be output as dynamic.

The server device 200a may be representative of the cloud-based data management system 102. The server device 200a may be representative of the application server 106. The server device 200a may be representative of the data server 110. The server device 200a may be representative of the external application server 116. The memory device 204 may be representative of the database 108 and the processing device 206 may be representative of the data server 110. The memory device 204 may be representative of the external database 118 and the processing device 206 may be representative of the external application server 116. For example, the database 108 and/or the external database 118 may be implemented as a block of memory in the memory device 204. The memory device 204 may further store instructions that, when executed by the processing device 206, perform various functions with the data stored in the database 108 and/or the external database 118.

Similarly, the client device 200b may be representative of the user device 104. The client device 200b may be representative of the smartphone 112. The client device 200b may be representative of the personal computer 114. The memory device 210 may store application instructions that, when executed by the processing device 212, cause the client device 200b to perform various functions associated with the instructions, such as retrieving data, processing data, receiving input, processing input, transmitting data, and so forth.

As stated above, the server device 200a and the client device 200b may be representative of various devices of the project management system 100. Various elements of the project management system 100 may include data storage and/or processing capabilities. Such capabilities may be rendered by various electronics for processing and/or storing electronic signals. One or more of the devices in the project management system 100 may include a processing device. For example, the cloud-based data management system 102, the user device 104, the smartphone 112, the personal computer 114, the external application server 116, and/or the external database 118 may include a processing device. One or more of the devices in the project management system 100 may include a memory device. For example, the cloud-based data management system 102, the user device 104, the smartphone 112, the personal computer 114, the external application server 116, and/or the external database 118 may include the memory device.

The processing device may have volatile and/or persistent memory. The memory device may have volatile and/or persistent memory. The processing device may have volatile memory and the memory device may have persistent memory. Memory in the processing device may be allocated dynamically according to variables, variable states, static objects, and permissions associated with objects and variables in the project management system 100. Such memory allocation may be based on instructions stored in the memory device. Memory resources at a specific device may be conserved relative to other systems that do not associate variables and other objects with permission data for the specific device.

The processing device may generate an output based on an input. For example, the processing device may receive an electronic and/or digital signal. The processing device may read the signal and perform one or more tasks with the signal, such as performing various functions with data in response to input received by the processing device. The processing device may read from the memory device information needed to perform the functions. For example, the processing device may update a variable from static to dynamic based on a received input and a rule stored as data on the memory device. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processing device.

The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory device.

Various devices in the project management system 100 may include data communication capabilities. Such capabilities may be rendered by various electronics for transmitting and/or receiving electronic and/or electromagnetic signals. One or more of the devices in the project management system 100 may include a communication device, e.g., the communication device 202 and/or the communication device 208. For example, the cloud-based data management system 102, the user device 104, the smartphone 112, the personal computer 114, the application server 116, and/or the external database 118 may include a communication device.

The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth™ programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the aforementioned elements and/or features of the communication component.

Various of the elements in the project management system 100 may be referred to as a “server.” Such elements may include a server device. The server device may include a physical server and/or a virtual server. For example, the server device may include one or more bare-metal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

Various of the devices in the project management system 100, including the server device 200a and/or the client device 200b, may include a user interface for outputting information in a format perceptible by a user and receiving input from the user, e.g., the user interface 214. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

Various methods are described below. The methods may be implemented by the data analysis system 100 and/or various elements of the data analysis system described above. For example, inputs indicated as being received in a method may be input at the client device 200b and/or received at the server device 200a. Determinations made in the methods may be outputs generated by the processing device 206 based on inputs stored in the memory device 204. Correlations performed in the methods may be executed by the correlation module 206a. Inference outputs may be generated by the inference module 206b. Key data and/or actionable data may be stored in the knowledge database 204b. Correlations between key data and actionable data may be stored in the knowledge database 204b. Outputs generated in the methods may be output to the output database 204c and/or the client device 200b. In general, data described in the methods may be stored and/or processed by various elements of the data analysis system 100.

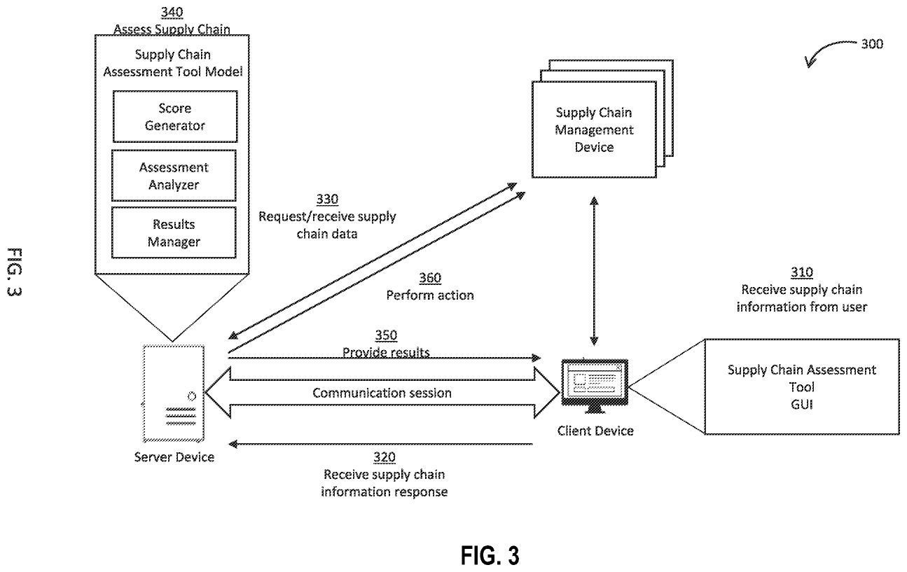

FIG. 3 illustrates an example implementation 300 associated with a supply chain assessment tool, according to an embodiment. In example implementation, a server device (e.g., the server device 110 of FIG. 1), a client device (e.g., the smartphone 112, the personal computer 114, or the like), and one or more supply chain management devices may be utilized to assess supply chains utilizing a supply chain assessment tool described herein. As shown in FIG. 3, a communication session is established between the server device and the client device. The communication session may include a peer-to-peer communication session, a web application session (e.g., using a web application or online platform associated with a supply chain assessment tool described herein), or the like.

As further shown in FIG. 3, the client device may include and/or utilize a supply chain assessment tool graphical user interface (GUI) that is associated with the supply chain assessment tool. Furthermore, as shown, the server device may include a supply chain assessment tool model that is associated with the supply chain assessment tool. The supply chain assessment tool model may include an artificial intelligence model, such as a machine learning model, that is trained to analyze and/or assess levels of risk associated with supply chains, as described herein.

As will be described further herein, example implementation 300 includes one or more tools for assessing risk or auditing supply chains. In some embodiments, electronic surveys may be provided to a client device and responses to questions within the electronic surveys may be automatically processed by an artificial intelligence to determine a set of action items and/or a scorecard. Verification data associated with the responses (e.g., data that confirms or supports information indicated by the responses) to the questions may be uploaded for verification and/or regulatory compliance, such as with industry standards according to a standards body (e.g., the American Society for Quality (ASQ), the International Organization for Standards (ISO), or the like). In some implementations, the supply chain assessment tool may verify certain supply chain information using verification data (e.g., uploads of evidence that aligns with or supports the supply chain information). As described herein, electronic survey data (e.g., responses to questions within the electronic survey and/or the verification data) may be automatically reassessed periodically (and/or according to a schedule), and new action items may be pushed to the client device, along with new questions and/or requests for verification data. After verifying the supply chain information, new questions and/or requests may be used to determine additional action items. The action items and electronic surveys may be accessible through a web application or website (e.g., hosted by the server device) and viewable on a graphical user interface of the client device. The graphical user interface may include features to assist the client with receiving the action items, viewing the action items, and/or accessing the electronic surveys and verification data uploads.

As shown in FIG. 3, and by reference number 310, the client device receives supply chain information (and/or data) from a user. For example, the client device may receive the supply chain information from responses received via a electronic survey that is displayed on the supply chain assessment tool GUI. In some implementations, prior to receiving the information from the user, the server device may provide the electronic survey to the client device (e.g., in response to a request from the client device or the user prompting the server device to provide the electronic survey).

An electronic survey associated with the supply chain assessment tool may include a variety of questions that are organized and/or provided to a user according to a decision tree. The decision tree may be configured to prompt the user to initially answer questions from relatively broad with respect to certain aspects of supply chains (e.g., questions to determine which industry that the particular supply chain may be utilized, questions to determine locations of portions of the supply chain, questions related to certain compliance requirements, etc.) to questions of relatively intermediate scope (e.g., questions related to certain organizations or entities within the supply chain, questions related to segments of the supply chain, questions related to products or services formed or transported through the supply chain, etc.) to questions of relatively narrow scope (e.g., questions related to specific devices or machines involved in the supply chain, questions related to the supply chain management devices that may be monitoring or controlling the supply chain, questions related to individuals operating the supply chain, questions related to schedules or plans for segments of the supply chain, etc.). The decision tree can be arranged to have any desired or requisite quantity of tiers and/or questions that would enable the supply chain assessment tool (and/or supply chain assessment tool model) to properly assess the supply chain as described herein. In some implementations, the electronic survey may be dynamically updated (e.g., based on responses received to various questions of the electronic survey) according to responses that are received from the user as the user completes or answers questions within the decision tree.

As described herein, the supply chain assessment tool model may be configured to utilize one or more natural language processing tools to analyze responses to questions of the electronic survey. In this way, the electronic survey may include open ended questions that enable a user of the client device to provide an unstructured response (e.g., a response using the user's natural language). Accordingly, users of various skill level, who individually may interpret questions within the electronic surveys differently and/or have a different level of knowledge with respect to the requested information in a given question of the electronic survey, may provide response to the electronic survey that can readily be interpreted by the supply chain assessment tool model to assess risk within a supply chain, as described herein.

Accordingly, the client device may receive supply chain information and/or data associated with a supply chain to permit the client device to provide the supply chain information to the server device, as described herein.

As further shown in FIG. 3, and by reference number 320, the server device receives a supply chain information response from the client device. The supply chain information response may include the supply chain information and/or data (e.g., verification data) provided by the user in connection with the electronic survey. The server device may receive the supply chain information response in a batch processing manner (after the user completes the electronic survey and/or answers a set of questions of the electronic survey) and/or as multiple individual responses or answers to the electronic survey. As described above, in some implementations, the server device may provide or update the electronic survey according to certain responses within the electronic survey.

Accordingly, the server device may receive one or more supply chain information responses from the client device to permit the server device to obtain data from the supply chain management devices and/or assess the supply chain, as described herein.

As further shown in FIG. 3, and by reference number 330, the server device may request and/or receive supply chain data from one or more of the supply chain management devices. For example, based on responses received by the client device, the supply chain management device may identify the supply chain management devices that can provide data that is specific to the supply chain that is to be assessed.

The supply chain management devices may include one or more sensors associated with the supply chain (e.g., temperature sensors, speed sensors, location sensors, content sensors, pressure sensors, and/or other sensors associated with objects or products of the supply chain) and/or control devices associated with the supply chain (e.g., actuators, computers, robots, equipment, or other machines that control movement of objects and/or products associated with the supply chain). Furthermore, the supply chain management devices may include third party devices or platforms that are configured to store or manage information associated with managing compliance requirements for supply chains. More specifically, the supply chain management devices may include databases or platforms that store and/or indicate safety requirements, quality requirements, or other industry standards that are associated with a supply chain.

In some embodiments, the supply chain data may include verification data that is associated with one or more responses identified in the supply chain information. For example, a response may identify an aspect or characteristic of the supply chain (e.g., a location, a product, a type of equipment, etc.) and the supply chain data may include verification data that supports and/or confirms that a provided response is accurate (e.g., that the location is accurate, that the product is accurate, that the type of equipment is accurate, and so on). Accordingly, the supply chain management devices may be configured to provide verification data that may be used to verify supply chain information provided by the client device (e.g., in response to the electronic survey). Based on verifying the supply chain information using the verification data, the supply chain assessment tool may perform an assessment of the supply chain based on the supply chain information, the verification data, and/or the supply chain data from the supply chain management devices.

As further shown in FIG. 3, and by reference number 340, the server device assesses the supply chain. For example, the server device may utilize the supply chain assessment tool model to assess the supply chain as described herein. In example implementation 300, the supply chain assessment tool model includes a score generator, an assessment analyzer, and a results manager. The supply chain assessment tool model may include and/or utilize one or more artificial intelligence models (e.g., a machine learning model, a deep learning model, or the like) that are configured to assess risk (or audit) supply chains utilizing the score generator, the assessment analyzer, and/or the results manager. For example, the score generator may include or utilize a first artificial intelligence model that determines a score for certain aspects or features of the supply chain (e.g., compliance scores, timeliness scores, quality scores, efficiency scores, etc.), the assessment analyzer may include and/or utilize a second artificial intelligence model that analyzes risk associated with a supply chain (e.g., based on the scores determined by the score generator), and the results manager may include or utilize a third artificial intelligence model that performs one or more actions based on results of the risk assessment.

The supply chain assessment tool model may include one or more machine learning models that are trained to assess risk and/or determine levels of risk associated with certain aspects of a supply chain. A machine learning model described herein may include a random forest model, a linear regression model, a neural network, a convolutional neural network (CNN) model, a deep neural network (DNN) model, a Siamese network model, and/or another type of machine learning model. Machine learning training and/or usage described herein may be performed using a machine learning system. The machine learning system may be included within a computing device, a server, a cloud computing environment, or the like, such as the server device of FIG. 3, the project management system 100, or a device with the project management system 100.

As described herein, a machine learning model (e.g., the supply chain assessment tool model or one or more elements of the supply chain assessment tool model), may be trained, using a machine learning system, to assess risk associated with one or more supply chains, types of supply chains, one or more aspects of a supply chain, one or more segments of a supply chain, etc. For example, a machine learning model may be trained using a set of observations associated with a supply chain. The set of observations may be obtained from historical data associated with historical operations involving the supply chain, such as data gathered during one or more processes that were historically performed as described herein (e.g., through electronic survey responses associated with the supply chain, through verification data associated with the supply chain, through supply chain data associated with the supply chain, etc.). In some embodiments, the machine learning system may receive the set of observations (e.g., as inputs) from the client device and/or from the one or more supply chain management devices. In some embodiments, the set of observations and/or historical data may be associated with historical operations involving one or more other supply chains that are separate from a supply chain being assessed (e.g., other supply chains that may be similar to the supply chain being assessed, such as supply chains that produce a same product or service, supply chains in a same or similar location, supply chains that must abide by the same or similar compliance requirements, and so on).

The set of observations may include a feature set. The feature set may include a set of variables, and a variable may be referred to as a feature. A specific observation may include a set of variables (or feature values) corresponding to the set of variables. In some embodiments, the machine learning system may determine variables for a set of observations and/or variable values for a specific observation based on input received (e.g., by the supply chain assessment tool model) from the client device, the one or more supply chain management devices, and/or the server device. For example, the machine learning system may train the supply chain assessment tool model to identify a feature set (e.g., one or more features and/or feature values associated with a supply chain) by extracting the feature set from structured data (e.g., data associated with certain responses to the electronic survey that request a particular value or choice from set of choices and/or supply chain data associated with one or more of the supply chain management devices), by performing natural language processing to extract the feature set from unstructured data (e.g., a feature set associated with responses to open ended questions within the electronic survey), by receiving direct input or feedback from an operator of the machine learning system, and so on.

As an example, a feature set for a set of observations associated with a supply chain may include a first feature of assessment scores determined by the score generator (e.g., scores that indicate a status of the supply chain), a second feature of performance scores determined by the score generator (e.g., scores that indicate a level of performance associated with the supply chain), and a third feature of compliance scores determined by the score generator (e.g., scores that indicate whether the supply chain meets certain compliance or quality requirements).

The set of observations may be associated with a target variable (e.g., a risk level associated with a supply chain or an aspect of a supply chain). The target variable may represent a variable having a numeric value, may represent a variable having a numeric value that falls within a range of values or has some discrete possible values, may represent a variable that is selectable from one of multiple options (e.g., one of multiple classes, classifications, labels, etc.), may represent a variable having a Boolean value, or the like. The target variable value may represent a value that a machine learning model is trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some embodiments, the machine learning model may be trained on a set of observations that do not include a target variable. This may be referred to as an unsupervised learning model. In such a case, the machine learning model may learn patters from the set of observations without labeling or supervision, and may provide output that indicates such patterns, such as by using clustering and/or association to identify related groups of objects or items within the set of observations.

The machine learning model may train a machine learning model using the set of observations and using one or more machine learning algorithms, such as a regression algorithm, a decision tree algorithm, a neural network algorithm, a k-nearest neighbor algorithm, a support vector machine (SVM) algorithm, or the like. After training the machine learning model, the machine learning system may store the machine learning model as a trained machine learning model to be used to analyze new sets of observations (e.g., for a particular supply chain or for any number or group of supply chains).

Accordingly, in example implementation 300, after the supply chain assessment tool model is trained as described above, the server device may utilize or apply the supply chain assessment tool model on the supply chain information responses associated with the electronic survey and/or the supply chain data from the supply chain management devices. The supply chain assessment tool model may process the supply chain information responses and/or the supply chain data to assess levels of risk associated with aspects of a supply chain, determine action items to be performed (if necessary) on the supply chain, and/or automatically perform certain actions in order to address (or reduce) risk within the supply chain.

As further shown in FIG. 3, and by reference number 350, the server device provides results to the client device. For example, the server device may provide the results through a report that can be displayed via the GUI on the client device. The report may indicate instructions for a user to address risk within the supply chain that was identified and/or indicated by the supply chain assessment tool model.

According to some implementations, the supply chain assessment tool model may provide and/or indicate reminders to perform certain action items in connection with certain aspects of the supply chain to address or mitigate risk within the supply chain.

As further shown in FIG. 3, and by reference number 360, the server device performs an action associated with one or more of the supply chain management devices. For example, the supply chain assessment tool model may cause one or more of the supply chain management devices to adjust an operation (e.g., a setting of a control device) of the supply chain in order to automatically improve an aspect of the supply chain (e.g., to improve speed, timeliness, quality, or the like). The server device may cause the supply chain management device to adjust the operation based on an output from the supply chain assessment tool model. For example, the output may indicate that the supply chain assessment tool determined that a level of risk associated with the supply chain (or an aspect of the supply chain) satisfied a certain risk threshold. In some implementations, the supply chain assessment tool may provide an output that includes one or more instructions for a user associated with certain action items to be performed. Additionally, or alternatively, based on an output of the supply chain assessment tool model, the server device may provide one or more instructions (e.g., executable instructions) to the supply chain management devices to cause the supply chain management devices to automatically perform an action associated with a certain action item (e.g., in order to address the risk or reduce the level of risk identified by the supply chain assessment tool model).

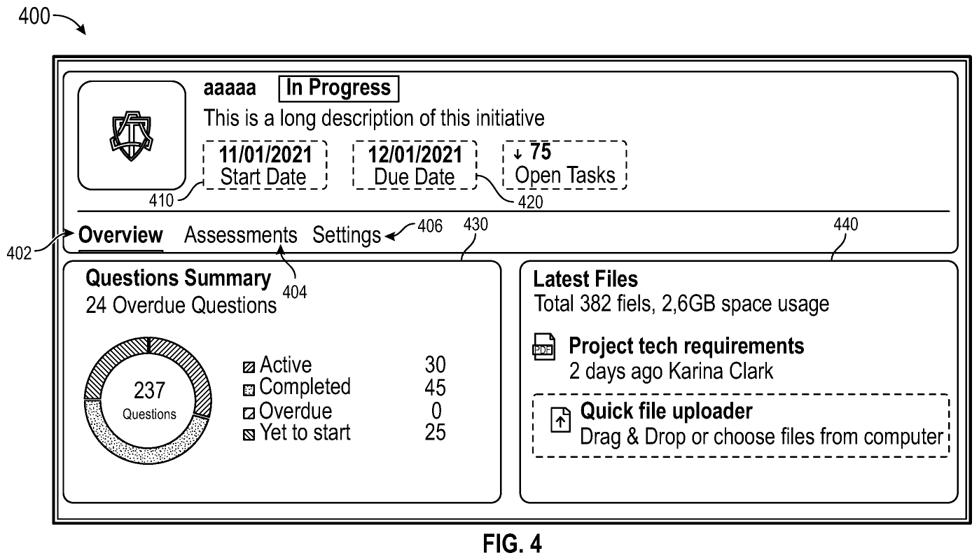

FIG. 4 illustrates a first graphical user interface 400 for accessing supply chain assessment tools at client device 200b, according to an embodiment. The first graphical user interface 400 may enable a user to quickly digest information about supply chains or supply chain risks by organizing the information in graphical user interfaces, tabbed pages, and/or dashboards. The first graphical user interface 400 includes an Overview tab 402 that enables the user to quickly and easily view what questions may need to be answered and/or what files (e.g., as verification data) need to be uploaded, as well as recommendations and other information. Tabs are available that allow a client to navigate from an overview of the supply chain, to assessments of the supply chain, and to allow the customer or client to change the settings for the tool via the Overview tab 402, an Assessment tab 404, and a Settings tab 406, respectively.

As shown, the interface may display start dates 410 and due dates 420 for each question or element of an electronic survey and/or for each action item. The graphical user interface may also display how many questions have been answered and/or a summary 430 of the status of all of the questions presented (i.e., active, completed, overdue, yet to start), a logo, a title label, a description label, a tabbed navigation bar, and number of open tasks. The graphical user interface may also contain a dashboard 440 or element showing uploaded files and related information, such as what evidentiary files have been uploaded, which are outstanding, the upload date, the uploading person, etc. In some embodiments, the tool is web-based and accessed over an internet connection of a client device. In some embodiments, one or more of the graphical user interface elements may be contained or organized in interfaces, sub interfaces, dashboards, or the like.

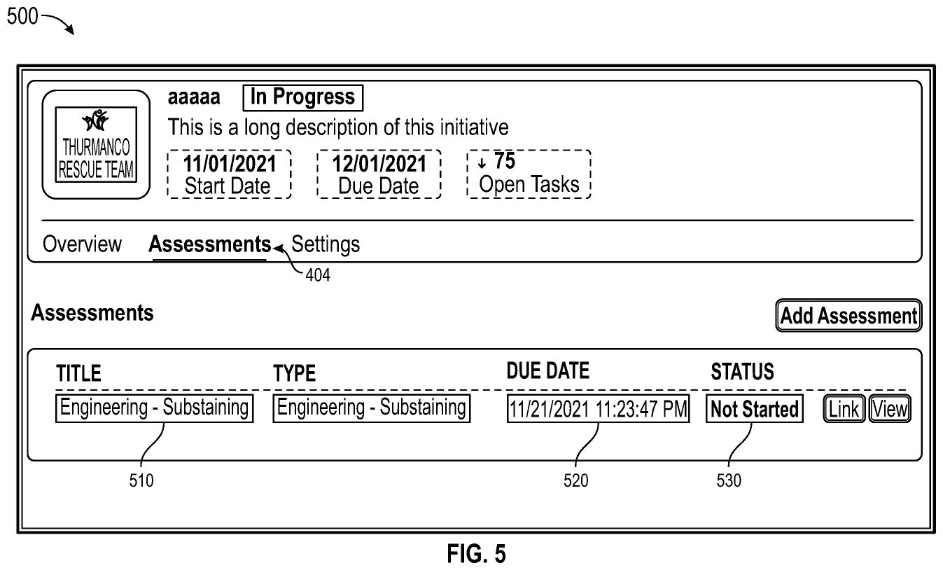

FIG. 5 illustrates a second graphical user interface 500 for accessing supply chain assessment tools at the client device 200b, according to an embodiment. As shown, the interface 500 is similar to the interface 400 except that the Assessments tab 404 has been navigated to by being clicked on. In the example shown, the assessment category 510 (engineering—sustaining) is shown with the due date 520 and status 530 for the assessment category.

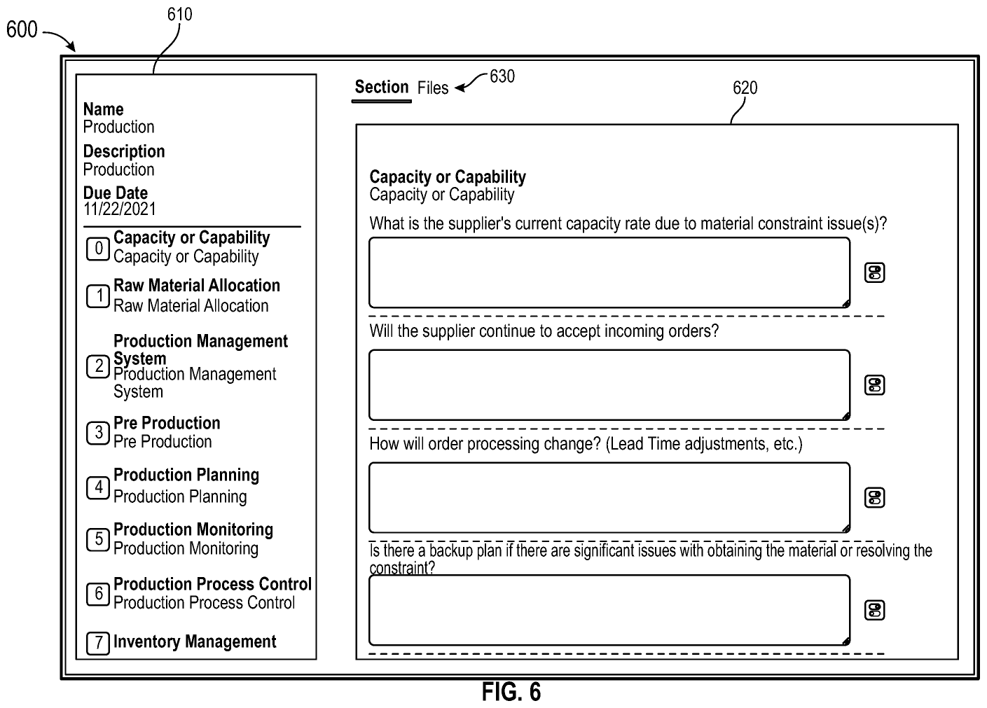

FIG. 6 illustrates a third graphical user interface 600 for accessing supply chain assessment tools at the client device 200b, according to an embodiment. As shown, the interface 600 may include a first graphical user interface element containing a contents element 610, a questions element 620, and a navigation tab element 630. The contents element may allow a user to select from electronic survey categories associated with certain aspects of a supply chain, such as capacity or capability, raw material allocation, production management system, etc. The navigation tab element may allow the user to navigate between a electronic survey for that category and a file upload for that category. In some embodiments, an upload may be required before a user is able to submit a response. By having evidence of electronic survey answers included and validated via the upload, the tool may be able to satisfy supply chain audits according to ASQ and ISO standards.

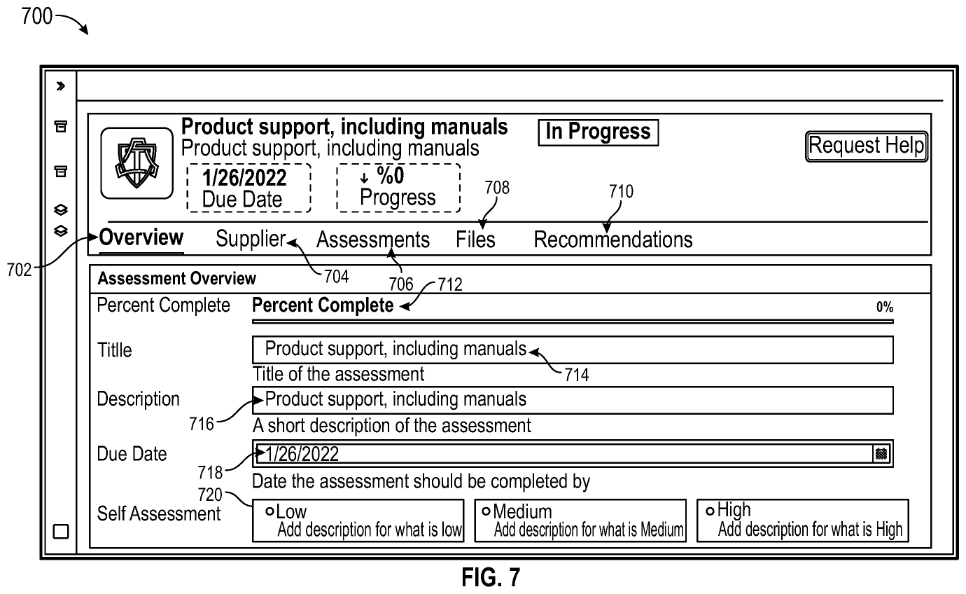

FIG. 7 illustrates a fourth graphical user interface 700 for supply chain assessment tools at the client device 200b, according to an embodiment. The fourth graphical user interface 700 may include one or more graphical user interface elements for navigating between an Overview tab 702, a Supplier tab 704, an Assessment tab 706, a Files tab 708, and a Recommendations tab 710. When the Overview tab 702 is navigated to, the interface 700 may include one or more graphical user interface elements displaying a percent complete 712, a title 714, a description 716, a due date 718, and a self-assessment 720. For example, a percent complete element may be selected from a contents tab, and one or more graphical user interface elements relating to the percent complete may be displayed, such as a title of the assessment, a short description of the assessment, a date the assessment should be completed by, and a radio button description selector for low, medium, or high. It will be appreciated by one of ordinary skill in the art that the arrangement of graphical user interface elements shown is but one example of suitable arrangements of graphical user interface elements.

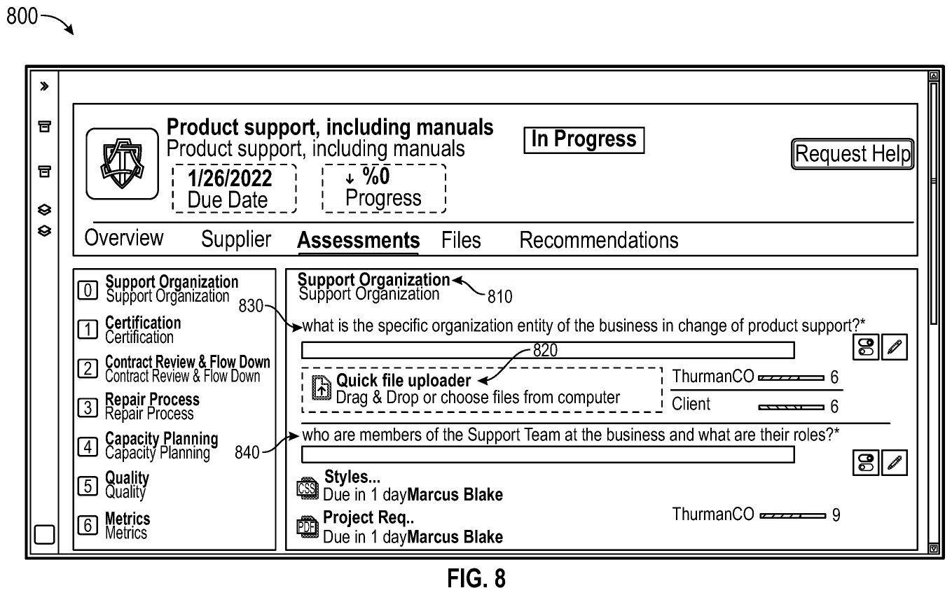

FIG. 8 illustrates a fifth graphical user interface 800 for accessing supply chain assessment tools at the client device 200b, according to an embodiment. As shown, the fifth graphical user interface 800 is similar to the fourth graphical user interface 700, except that a Support Organization element 810 of a contents tab element of an Assessment tab has been navigated to. In the depicted example, the Support Organization tab includes one or more graphical user interface elements displaying a file uploader 820, a question 830 relating to the entity in charge of product support for a business, a question 840 related to members of a business support team and their roles, etc.

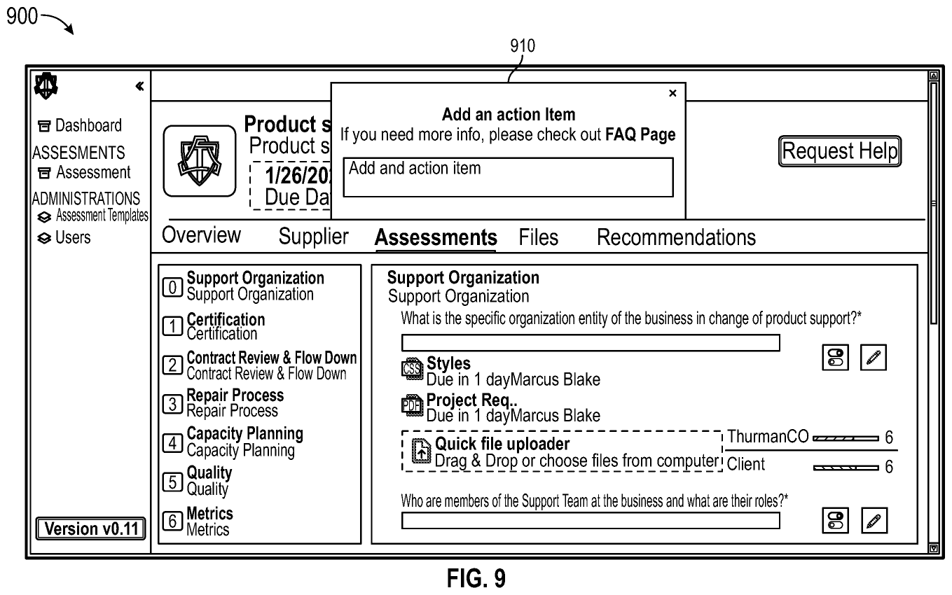

FIG. 9 illustrates a sixth graphical user interface 900 for accessing supply chain assessment tools at the client device 200b, according to an embodiment. The sixth graphical user interface 900 may be similar to the fifth graphical user interface 800 except that an add action item element has been selected, causing a prompt 910 (or popup) requesting the added action to be typed into a text box.

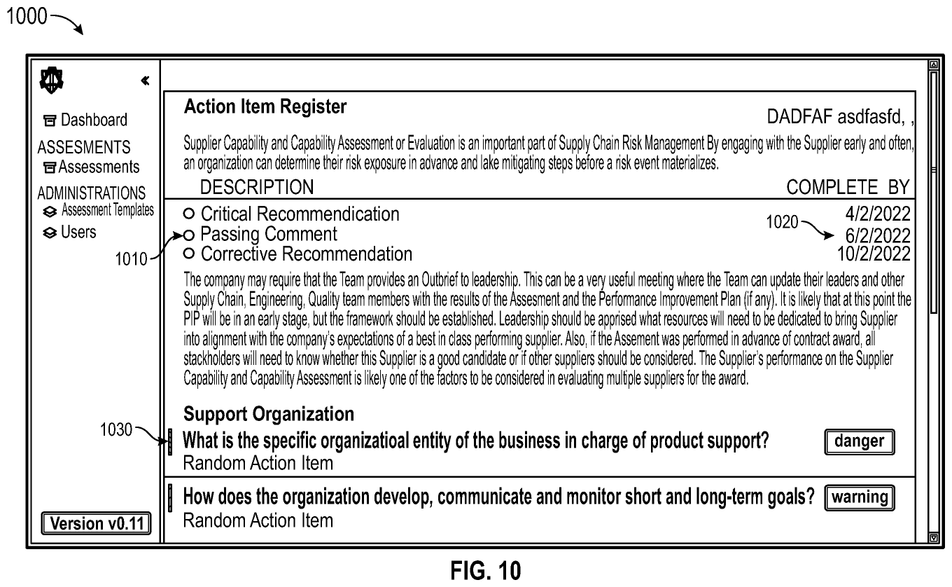

FIG. 10 illustrates a seventh graphical user interface 1000 for accessing supply chain assessment tools at the client device 200b, according to an embodiment. The seventh graphical user interface 1000 may include one or more graphical user interface elements for navigating between to or between the first, second, third, fourth, fifth, and sixth graphical user interfaces. The seventh graphical user interface 1000 may also include one or more graphical user interface elements displaying action item register information, such as color-coded tags 1010 for critical recommendation, passing comment, and corrective recommendation, along with complete by dates 1020 for each item. In some embodiments, the seventh graphical user interface may also display support organization items 1030, which may also be color coded red or yellow for danger or warning, respectively. It will be appreciated that any suitable colors may be used for color-coded categories, and that the exemplified arrangement of graphical user interface elements is but one suitable arrangement for accessing supply chain assessment tools.

The graphical user interfaces may include a graphical organizer container and one or more graphical data containers. The one or more graphical data containers may be nested in the graphical organizer container. The graphical organizer containers may include one or more of the features mentioned above and may provide a visual cue to a user regarding supply chain risk. The one or more graphical data containers may be organized in the graphical organizer container according to level of risk.

According to some embodiments, a customer may view a service description for the Supplier Capability and Capacity Assessment (SCCA) and request a free limited trial account to evaluate the product. If satisfied, the customer's account is activated, which will provide the customer complete access to a full range of curated electronic surveys that will assess the customer company's risk for supply chain disruption. The customer can flow this assessment down to the customer's sub-tier suppliers, such as by providing the customer access to the electronic surveys. As described further herein, customers can sign up for a subscription service that will automatically provide them with updates to the SCCA electronic surveys, audit reminders, and the ability to upload additional evidence (or verification data) as action items are completed, thus providing ongoing protection against supply chain disruption.

As used herein, a variable may refer to a data object of a software application. The variable may be referential, e.g., may reference to a particular data location. System memory for the variable may be drawn from a pool of memory allocated for the software application. The software application may include instructions to request a pool of memory sized based on permissions granted to the software application. An application running on a remote device may change the permissions associated with the local software application. The software application may include instructions to request greater memory allocation based on being granted additional permissions.

The graphical user interfaces 400, 500, 600, 700, 800, 900, may represent visual elements associated with a manager user account, an associated user account, a support staff user account, a customer or client account, and so forth. Such user accounts may be associated with risk assessment or the supply chain risk assessment system. The manager may oversee the account. The associate may perform specific tasks for the account and/or various primary tasks associated with the account. The support staff may perform various support tasks associated with the account, such as billing, scheduling, and so forth. The customer or client may be the individual and/or entity that has requested and/or paid for the account.

Some of the graphical user interface elements may be modified and/or omitted when the graphical user interface is associated with the customer or client account. Some of the graphical user interface elements may be visible and uneditable (e.g., the element is not responsive to an interaction with the element) when the graphical user interface is associated with a customer and/or client account.

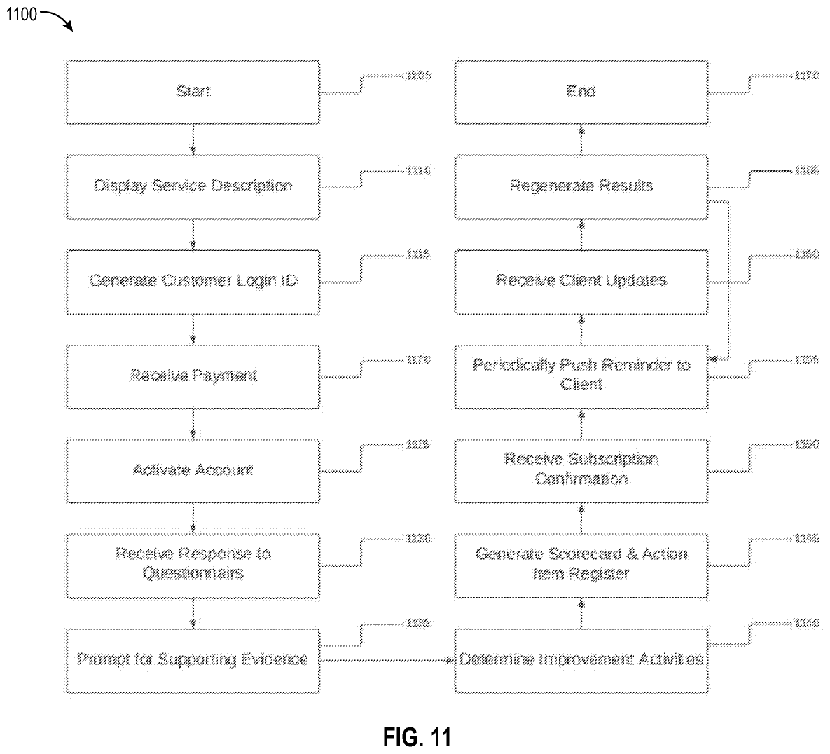

FIG. 11 illustrates a first supply chain assessment method 1100, according to an embodiment. As shown, the method 1100 may begin at starting block 1105.

From stage 1105 where the method 1100 begins, the method may proceed to stage 1110 where the processing device instructs the client device to display information about risk assessment or auditing services. For example, displaying information on graphical user interface of a client device belonging to the customer or client.

From stage 1110 where description of services is displayed, the method 1100 may proceed to stage 1115 where the processing device generates a customer login ID in response to input from the client device.

From stage 1115 where the customer login identifier is generated, the method 1100 may proceed to stage 1020 where payment is received and processed for a paid account.

From stage 1120 where the payment is received, the method 1000 may proceed to stage 1025 where the free trial account is activated. In some embodiments, an activated account may have access to a full set of risk assessment electronic surveys via the networked connection of a client device.

From stage 1125 where the account is activated, the method 1100 may proceed to stage 1130 where the customer's response to one or more electronic surveys is received, such as when a customer submits answers using a client device.

From stage 1130 where the response to the one or more electronic surveys is received, the method 1100 may proceed to stage 1135 where the user is prompted for supporting evidence, such as images or documents necessary to demonstrate the accuracy or otherwise support the answers to the electronic survey questions. In some embodiments, the method may also include preventing the client from progressing without an upload.

From stage 1135 where the user is prompted for supporting evidence, the method 1100 may proceed to stage 1140 where the processing device determines improvement activities, such as by using artificial intelligence or a decision tree to identify areas where improvement may be made.

From stage 1140 where improvement activities are determines, the method 1100 may proceed to stage 1145 where a scorecard and/or an action item register is generated. The scorecard may comprise a percentage credited out of a total possible number of points according to a scoring system. The action items may include improvement activities generated in response to the answers to one or more of the electronic survey items or an assessment of the evidentiary support. For example, if the question is, “does the company have a documented process for tracking failures at Functional Testing” and the answer is, “no,” then the Action Item may be “create and document a process to track failures at Functional Testing.”

From stage 1145 where the scorecard and/or action item register is generated, the method 1100 may proceed to stage 1150 where a confirmation for a subscription service is received. In some embodiments, the subscription service may be periodic, such as month-to-month, seasonal, yearly, etc. In some embodiments, both a billing period and an update period may be selected, such that the customer is billed in a cycle according to the billing period, and the customer account is updated in a cycle according to the update period.

From stage 1150 where confirmation for a subscription service is received, the method 1100 may proceed to stage 1155 where reminders are periodically pushed to the client or customer, such as by having a reminder sent to a client device in suitable ways known in the art, such as text message or email. In some embodiments, the reminder may contain a hyperlink to the client's account. In some embodiments, pushing the reminder to the client may include updating action items, updating a scorecard, generating new electronic survey questions, and populating the client account with the updated action items, updated scorecard, and new electronic survey questions.

From stage 1155 where reminders are periodically pushed to the client, the method 1100 may proceed to stage 1160 where the processing device receives client updates, such as new responses to electronic surveys and/or new supporting evidence.

From stage 1160 where the client updates are received, the method 1100 may proceed to stage 1165 where the processing device may regenerate one or more results from the updated electronic survey or new supporting evidence, such as by updating the action items, updating the scorecard, generating new electronic survey questions, and populating the client account with the updated action items, updated scorecard, and new electronic survey questions.

From stage 1165 where results are regenerated, the method 1100 may comprise continuing to periodically push reminders, receive client updates, and regenerate results. In some embodiments, the method may comprise continuing to periodically push reminders, receive client updates, and regenerate results as long as a subscription is active. In some embodiments, when a subscription is no longer active, the method may proceed to stage 1170 where the method ends.

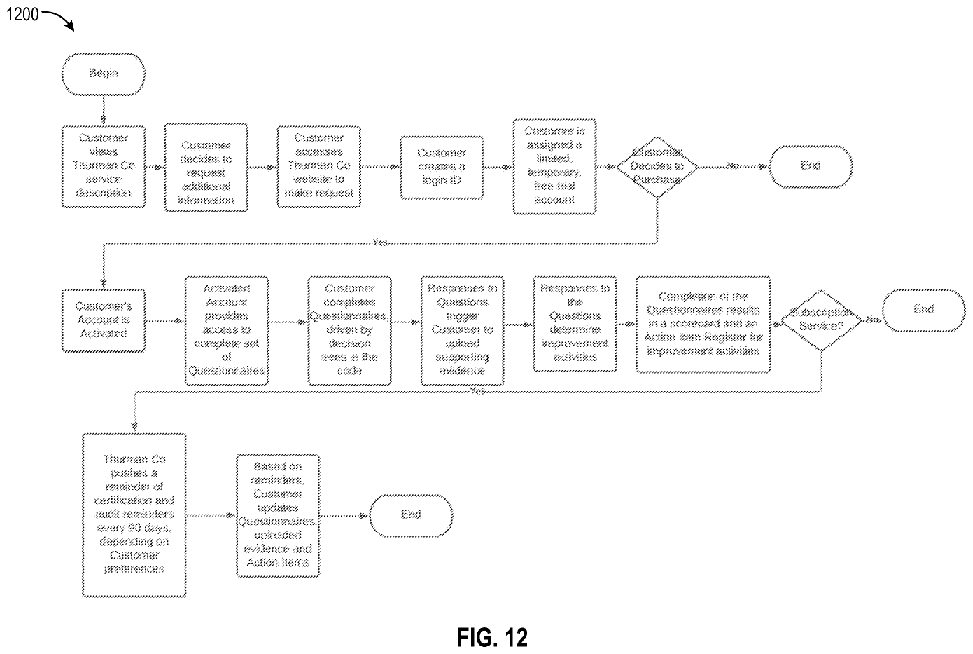

FIG. 12 illustrates a flow chart for a supply chain assessment system, according to an embodiment. As shown, FIG. 12 describes stages of use of the supply chain assessment tools during a customer process 1200 according to the embodiment. From a beginning stage, a customer views a service description at a proceeding stage. For example, a customer may visit a web page with the service description.

From the stage where the customer views the service description, a customer may decide to request additional information. From the stage where a customer may decide to request additional information, a customer may create a login ID. From the stage where a customer creates a login ID, the customer is assigned a temporary, limited, free trial account. The trial account may be an account that is limited by content—that is, that only allows access to a selection of the electronic surveys, or that is limited by duration—that is, that only allows access for a period of time, or both. Trial access may also be limited in any other suitable way known in the art. From the stage where the customer is assigned a trial account, the customer makes a decision whether to purchase. If the customer decides not to purchase, the trial account will expire.

If the customer decides to purchase, the customer may have the account activated. From the stage where the account is activated, the activated account provides access to a complete set of electronic surveys. From the stage where the access to the complete set of electronic surveys is provided, the customer may complete the electronic surveys. In some embodiments, the questions presented may be selected by a decision tree coded onto a web-based application. From the stage where the customer may complete the electronic surveys, the responses may trigger the customer to upload supporting evidence. From the stage where the customer may be triggered to upload evidence, the responses to the questions may determine improvement activities. From the stage where the responses to the questions may determine improvement activities, the completion of the electronic survey may result in a scorecard and/or an action item register for improvement activities.

From the stage where the completion of the electronic survey results in a scorecard and/or an action item register, a subscription service may be offered to the customer. For example, results from the electronic surveys and supporting evidence uploads may be weighted, and a composite scorecard may be calculated from the weighted results. If the customer declines the subscription service, the customer's use of the paid tools may end. In some embodiments, access to data generated during subscription may still be available, such as a scorecard or action item register.

If the customer accepts the subscription service, a reminder may be pushed to a client device of the customer periodically, such as every 90 days or an amount of time depending on customer preference. From the stage where a reminder may be pushed periodically, new electronic surveys, action items, updates, and requests for evidence uploads may be pushed to the client based on the periodic reminders. Periodic reminders, new electronic surveys, action items, updates, and requests for evidence uploads may continue to be pushed until the customer's use of the tools or subscription ends. Reminders may also include notifications of a pending audit, or deadlines for audits or other action items.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A device, comprising:
a memory device; and
a processor communicatively coupled with the memory device, wherein the processor is configured to:
provide a electronic survey to a client device, wherein:
the electronic survey includes one or more inquiries associated with operations of a supply chain;
receive, from the client device, a response associated with the one or more inquiries, the response is received as unstructured data;
process, using natural language processing, the response to determine supply chain information associated with the supply chain;
receive, from a supply chain management device, supply chain data associated with the supply chain management device, wherein the supply chain management device is associated with the supply chain;
verify the supply chain information based on the supply chain data;
process, based on verifying the supply chain information and using a supply chain assessment tool model, the supply chain information to determine a score associated with an aspect of the supply chain,
wherein the supply chain assessment tool model comprises a machine learning model that is trained based on historical data that includes a set of observations associated with historical operations of the supply chain;
determine, using the supply chain assessment tool model, a level of risk associated with the supply chain based on the score;
determine, using the supply chain assessment tool model, an action item for the supply chain based on the level of risk, the supply chain information, and the supply chain data; and
cause, based on the action item, the supply chain management device to adjust an operation associated with the supply chain to reduce the level of risk.

2. The device of claim 1, wherein inquiries of the electronic survey is provided to the client device using a decision tree and individual responses to the inquiries received during a communication session that is established between the device and the client device.

3. The device of claim 1, wherein the electronic survey is provided to the client device via a communication session of a web application that is hosted by the device and the supply chain information is received via the communication session.

4. The device of claim 1, wherein the score is indicative of at least one of:
a status of the aspect of the supply chain;
a performance level associated with the aspect of the supply chain;
a compliance level associated with the aspect of the supply chain; or
a quality associated with the aspect of the supply chain.

5. The device of claim 1, wherein the set of observations comprise historical data that is associated with second historical operations involving one or more other supply chains.

6. The device of claim 1, wherein the supply chain assessment tool model is trained to assess risk for other supply chains that are separate from the supply chain.

7. The device of claim 1, wherein the supply chain management device is caused, based on an output from the supply chain assessment tool model, to adjust the operation based on the level of risk satisfying a risk threshold.

8. The device of claim 1, further comprising
causing, based on an output from the supply chain assessment tool model, the client device to display, via a graphical user interface, the action item to enable a user of the client device to reduce the level of risk.

9. A method, the method comprising:
receiving, by a device and from a client device, supply chain information in a response associated with a electronic survey,
wherein the supply chain information identifies information associated with a supply chain;
receiving, by the device and from a supply chain management device, supply chain data associated with the supply chain management device that is associated with the supply chain;
processing, by the device and using a supply chain assessment tool model, the supply chain information and the supply chain data to determine a score associated with an aspect of the supply chain,
wherein the supply chain assessment tool model comprises a machine learning model that is trained based on a set of observations associated with assessing a supply chain;
determining, by the device and using the supply chain assessment tool model, a level of risk associated with the supply chain based on the score;
determining, by the device and using the supply chain assessment tool model, an action item for the supply chain based on the level of risk, the supply chain information, and the supply chain data; and
performing, by the device and based on the action item, an action associated with the supply chain to reduce the level of risk.

10. The method of claim 9, wherein the electronic survey is provided to the client device based on receiving a request for the electronic survey prior to receiving the supply chain information.

11. The method of claim 9, wherein the electronic survey is provided to the client device via a web application hosted by the device and the supply chain information is received via the web application.

12. The method of claim 9, wherein the supply chain management device comprises at least one of:
a sensor configured to monitor the aspect of the supply chain, or
a control device configured to control the aspect of the supply chain.

13. The method of claim 9, wherein the set of observations comprise historical data that is associated with historical operations involving the supply chain.

14. The method of claim 9, wherein the supply chain assessment tool model processes the response using natural language processing.

15. The method of claim 9, wherein performing the action comprises:
automatically causing the supply chain management device to adjust an operation associated with the supply chain.

16. The device of claim 9, wherein performing the action comprises:
causing the client device to display, via a graphical user interface, the action item to enable a user of the client device to reduce the level of risk.

17. A system, comprising:
a client device; and
a server device, comprising a supply chain assessment tool model, the server device being configured to:
process, using natural language processing, a response to a electronic survey associated with assessing a supply chain,
wherein the response is received from the client device;
determine, based on processing the response, supply chain information associated with the supply chain;
process, using a supply chain assessment tool model, the supply chain information to determine a level of risk associated with the supply chain,
wherein the supply chain assessment tool model comprises a machine learning model that is trained based on historical data associated with assessing risk within supply chains;
determine, using the supply chain assessment tool model and based on the level of risk, an action item for the supply chain to reduce the level of risk; and
cause, based on the action item, the client device or a supply chain management device associated with the supply chain to perform an action associated with the action item.

18. The system of claim 17, wherein the response is received as unstructured data and is associated with a question of the electronic survey that was provided to the client device using a decision tree that is configured to provide inquiries of the electronic survey.

19. The system of claim 17, wherein the historical data is associated with historical operations involving the supply chain.

20. The system of claim 17, wherein the action item is determined based on the level of risk satisfying a risk threshold.
